(19) United States
(12) Patent Application Publication
(10) Pub. No.: US 2008/0162193 A1
(43) Pub. Date: Jul. 3, 2008

(54) Data Recording System and Data Recording Method

(75) Inventor: Roland Voggenauer, Prien am Chiemsee (DE)

Correspondence Address: OBLON, SPIVAK, MCCLELLAND MAIER & NEUSTADT, P.C., 1940 DUKE STREET, ALEXANDRIA, VA, 22314, US

(73) Assignee: SWISS REINSURANCE COMPANY, ZUERICH (CH)

(21) Appl. No.: 11/817,607

(22) PCT Filed: Mar. 2, 2005
(86) PCT No.: PCT/CH2005/000121

§ 371 Date: Aug. 31, 2007

(51) Int. Cl. G06Q 40/00; G01C 22/00

(52) U.S. Cl. 705/4

(57) ABSTRACT

To record mileage of a motor vehicle to determine a motor vehicle insurance premium, a portable data carrier is connected to a data input terminal, which is connected to a fuel pump. The data input terminal receives a distance traveled data item from the motor vehicle, for example from a transmitter on the motor vehicle or from the data carrier. A vehicle identifier of the motor vehicle stored on the data carrier is read by the data input terminal and is transmitted together with the distance traveled data item to a computer-based control center via a telecommunications network. A plurality of transaction records assigned to the motor vehicle, in each case with a time data item, are stored in the control center. As a function of the stored distance traveled data items, the control center determines a total distance traveled by the motor vehicle in the calculation period.

### TECHNICAL FIELD

The present invention relates to a computer based data recording system and a computer implemented data recording method. The present invention relates in particular to a computer based data recording system and a computer implemented method for recording the mileage of a motor vehicle in order to determine a motor vehicle insurance premium.

### PRIOR ART

It has become apparent that the actual mileage, in particular the actual distance traveled (distance) with a motor vehicle, is one of the decisive tariff features in motor vehicle insurance. Typically, the mileage is recorded by the insured person providing an estimate of the anticipated annual distance traveled, for example the number of kilometers or mileage, during the insurance period when the insurance is applied for. This estimate is generally very imprecise and subsequent recordings, for example by questioning the insured persons are extremely laborious and time consuming.

Patent document U.S. Pat. No. 6,064,970 describes a vehicle monitoring system for determining insurance costs. According to U.S. Pat. No. 6,064,970 respective different data elements which relate to the operating state of the vehicle and to actions of the driver are recorded in the motor vehicles. Inter alia, the number of actual kilometers (miles) traveled, the kilometer reading, the speeds at which the vehicle traveled and the current geographic position are continuously recorded in the vehicle and stored. The stored data are transmitted periodically by a mobile radio from the vehicle to a control center where they are used to determine a supplementary fee or a bonus for the motor vehicle insurance premium. The system according to U.S. Pat. No. 6,064,970 has the disadvantage that all the vehicles have to be provided with an electronic data recording system and with a communications module which is connected thereto, which is both costly and excludes vehicles from the mileage-dependent calculation of insurance costs which are not equipped with these components. In addition, the continuous recording of the current geographic position of a large number of insured persons is felt to be an intrusion into the private sphere and is rejected for reasons of data protection.

### SUMMARY OF THE INVENTION

An object of the present invention is to propose a computer based data recording system and a computer implemented data recording method for recording the mileage of a motor vehicle in order to determine a motor vehicle insurance premium which does not have the disadvantages of the prior art. In particular one object of the present invention is to propose a computer based data recording system and a computer implemented method for recording the mileage of a motor vehicle in order to determine a motor vehicle insurance premium which, on the one hand, does not require estimates of the mileage before or after the insurance is applied for but, on the other hand, also does not require electronic data recording systems and associated communications modules to be installed in all the participating vehicles.

According to the present invention, these objectives are achieved in particular by means of the elements of the independent claims. Further advantageous embodiments can also be found in the dependent claims and the description.

The abovementioned objectives are achieved by means of the present invention in particular by virtue of the fact that when the data relating to the mileage of a motor vehicle are recorded in order to determine a motor vehicle insurance premium, a portable data carrier is connected to a data terminal which is connected to a fuel pump. The data input terminal reads a vehicle identifier for the motor vehicle which is stored on the data carrier. The data carrier is, for example, embodied as a chip card with a contactless and/or contact based interface. Furthermore, the data terminal receives a distance traveled data item, for example a kilometer reading, from the motor vehicle. The data input terminal transmits a transaction record which comprises the vehicle identifier and the distance traveled data item, to a computer based control center via a telecommunications network. The control center stores a plurality of transaction records assigned to the motor vehicle, in each case with a time data item, and determines, as a function of the stored distance traveled data items, a total distance traveled by the motor vehicle in a defined billing period. As a function of this total distance traveled, the control center determines the motor vehicle insurance premium for the billing period. Recording the vehicle identifier and the distance traveled data item in a data input terminal connected to a fuel pump permits the actual mileage to be recorded on a vehicle specific basis when the motor vehicle is refueled, without data recording systems for operating the parameters and communications modules having to be installed in the motor vehicle for that purpose. Furthermore, the data is recorded under the control of the insured person who can himself decide when he wishes to connect the data carrier to the data input terminal when he refuels the vehicle. At the cost of missing a data recording, the insured person can thus intentionally protect his private sphere at selected moments. Finally, recording the data by means of the data input terminal also has the advantage that the mobile radio network which is used in the prior art is not loaded by periodic data transmissions from a plurality of motor vehicles.

In one preferred embodiment variant, the data carrier is connected to a writing device which is connected to an odometer of the motor vehicle. The writing device stores a distance traveled, measured by the odometer, in the data carrier. The data carrier is later connected to the data input terminal and the data input terminal reads the distance traveled from the data carrier. Transmitting the distance traveled data items from the motor vehicle to the data input terminal by means of a contactless or contact based data carrier has the advantage that the user (insured person) does not have to input these data items manually so that input errors can be avoided.

In one embodiment variant, a transmitting device which is connected to an odometer of the motor vehicle emits a distance traveled measured by the odometer. The data carrier is connected to the data input terminal and the data input terminal receives the emitted distance traveled from the transmitting device when the data carrier is connected to the data input terminal. The direct transmission of the distance traveled data items from the transmitter to the input terminal prevents any possibility of tampering with the data, which cannot be completely ruled out with a data carrier.

In a further preferred embodiment variant, the control center determines, on the basis of a terminal identifier contained in the transaction record, a geographic position which was traveled through by the motor vehicle in the billing period. The control center then determines the motor vehicle insurance premium as a function of the geographic positions which were traveled through by the motor vehicle in the billing period. Without continuously recording the current geographic position it is possible, by using the terminal identifier to determine geographic positions which have been traveled through, to calculate a premium in which the different risks of geographic regions are taken into account.

In one embodiment variant, the fuel pump which is connected to the data input terminal transmits a quantity data item for fuel, which has been input into the motor vehicle, to the data input terminal. The data input terminal inputs the quantity data item for fuel into the transaction record. The control center determines, as a function of stored quantity data items for the fuel, a total fuel quantity which has been input into the motor vehicle in the billing period. The control center then determines the motor vehicle insurance premium for the billing period as a function of the total fuel quantity. Via recording and determining the consumed fuel quantity it is possible for various levels of driving behavior (from defensive to aggressive) to be determined and taken into account in the calculation of the premium.

In a further embodiment variant, the data input terminal reads a performance identifier which is stored on the data carrier. The data input terminal transmits the transaction record to the control center which is determined by the performance identifier.

The vehicle identifier is preferably assigned to an insured person in the control center. The control center bills the insured person with the motor vehicle insurance premium for the billing period and the costs for the total fuel quantity which is input into the motor vehicle in the billing period.

### BRIEF DESCRIPTION OF THE DRAWINGS

An embodiment of the present invention will be described below using an example. The example of the embodiment is illustrated by the following appended figures:

FIG. 1 shows a block diagram which is a schematic illustration of a motor vehicle with an odometer, a data input terminal which is connected to a fuel pump and a control center which is connected to the data input terminal via a telecommunications network.

FIG. 2 shows a flowchart which illustrates an example of a process sequence during the recording of data for the mileage of the motor vehicle in the data input terminal.

### WAYS OF IMPLEMENTING THE INVENTION

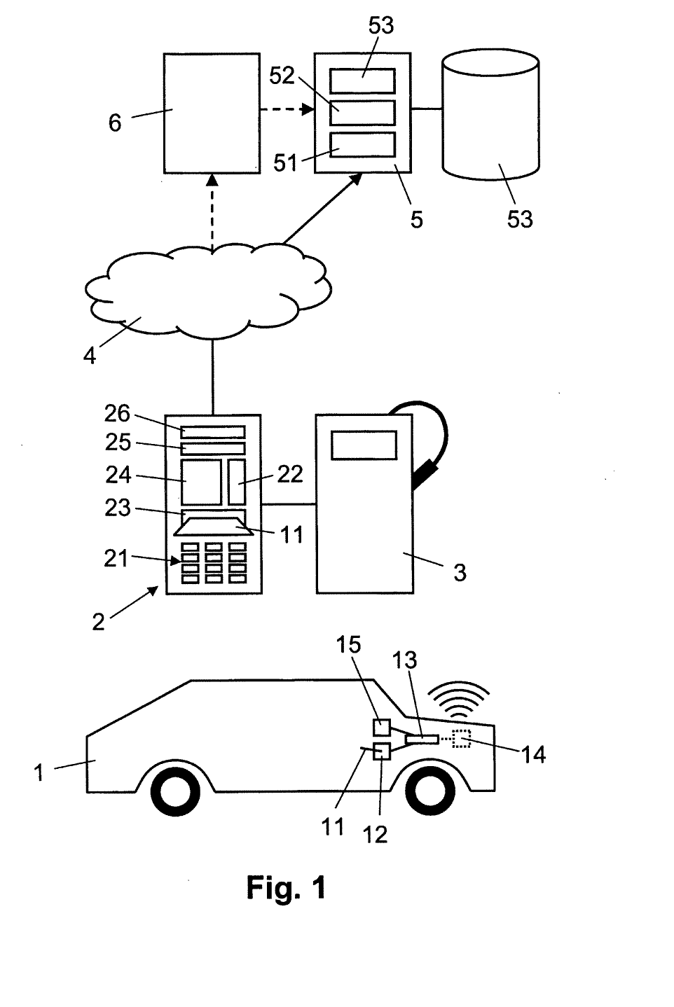

In FIG. 1, the reference symbol 1 designates a motor vehicle which is operated with fuel such as petrol, diesel or gas. The motor vehicle 1 can also be operated electrically, in which case the fuel is supplied in the form of electric current.

As is schematically illustrated in FIG. 1, the motor vehicle 1 comprises an odometer 13, i.e. a kilometer counter or mile counter, which is connected to a display 15. The odometer 13 is connected, for example, to a tachometer or an on-board computer. In various embodiment variants, the odometer 13 is additionally connected to a writing device 12 or to a transmitting device 14.

The writing device 12 is configured to transmit a distance traveled data item, for example current kilometer reading or mileage, from the odometer 13 to the data carrier 11 and to store it there. This writing process takes place when the data carrier 11 is connected to the writing device 12, that is to say, depending on the embodiment variant, when the data carrier 11 is introduced into the writing device 12 (contact based) or when the data carrier 11 is located within an interface region of the writing device 12 (contactless). The data carrier 11 is embodied, for example, as a chip card which can be connected (for example inductively) to the writing device (12) via contacts or via a contactless interface. The data carrier 11 can, for example, also be integrated into a vehicle key or into a wrist watch. The vehicle identifier of the motor vehicle 1 is stored on the data carrier 11. The vehicle identifier corresponds, for example, to the official motor vehicle registration number which is stored on the number plates of the motor vehicle 1 or is some other unique identifier of the motor vehicle 1.

The transmitting device 14 is configured to transmit a distance measurement data item from the odometer 13 via radio to a corresponding receiving device 25 of the data input terminal 2. Depending on the embodiment variant, the transmitting device 14 emits the distance measurement data item periodically or transmits it only on request by the receiving device 25 in accordance with a bidirectional communications protocol. During the periodic emission, the distance traveled data item for assignment to the motor vehicle (1) is transmitted, for example together with a transmitter identifier which is also stored on the data carrier 11. The transmitting device 14 is configured to communicate with the receiving device 25 within a defined communications range so that the possibility of data communication is restricted to motor vehicle 1 which are located at the fuel pump 3 for the purpose of refueling. The communications range has, for example, a radius of several meters, for example 3 to 5 meters. The transmitting device 14 preferably comprises a device interface, for example what is referred to as a Bluetooth interface.

As is illustrated schematically in FIG. 1, the data input terminal 2 is connected to a fuel pump 3. When a motor vehicle 1 is refueled, the quantity data item for the fuel which is input into the motor vehicle 1 is transmitted by the fuel pump 3 via the connection to the data input terminal 2. Although the data input terminal 2 and the fuel pump 3 are illustrated as separate devices in FIG. 1, they can also be installed as a unit in a common housing.

The data input terminal 2 comprises a control application 22 which is configured to receive, from the fuel pump 3, the quantity data item for the fuel which is input into the motor vehicle 1 and to store it. The control application 22 is preferably a programmed software module which is executed on a processor of the data input terminal 2. The data input terminal 2 also has a reading device 23 for reading data from the data carrier 11 when the data carrier 11 is connected to the data input terminal 2, i.e. to the reading device 23. Depending on the embodiment variant, the data carrier 11 is placed in contact with the reading device 23, in a contact based fashion by inserting it into the reading device 23, or in a contactless fashion by positioning it within a defined interface area of the reading device 23 of, for example, less than one or two meters diameter. The data input terminal 2 also comprises a display 24 for displaying data and operator control elements 21 in order to permit a user to input data. Finally, the data input terminal 2 also comprises a communications module 26 which permits data to be transmitted via the telecommunications network 4 to the computer based control center 5 or to the computer based billing point 6.

The telecommunications network 4 is preferably a fixed network and comprises, for example, the public switched telephone network, an ISDN network (Integrated Services Digital Network), an LAN (Local Area Network), a WAN (Wider Area Network) and/or the Internet. The telecommunications network 4 can additionally or alternatively also comprise a mobile radio network, for example a GSM (Global System for Mobile Communications) or UMTS (Universal Mobile Telephone System) network.

Control center 5 comprises a data recording module 51, a premium calculating model 52 and a calculation module 53 which are embodied as programmed software modules. The control center 5 is additionally connected to a data base 53 which is embodied on the same computer as the control center 5 or on a separate computer.

The person-related and vehicle-related data of insured persons who have bought a motor vehicle insurance policy are stored assigned in each case to an insured personal number in the data base 53. In particular, in each case the vehicle identifier of the motor vehicle 1 is stored assigned to the insured person number in the data base 53. An insured person can also be assigned a plurality of vehicle identifiers. In addition, data items relating to the motor vehicle 1 are assigned in a stored manner to the vehicle identifier, for example the make, type, power class, typical average petrol consumption for town cycle and long distance cycle etc.

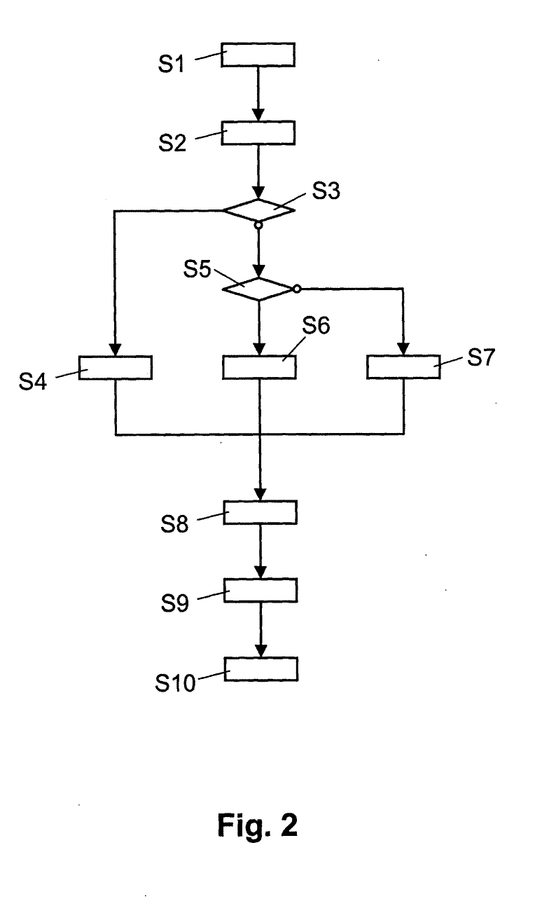

The recording of the data for the mileage of the motor vehicle 1 is described in the following sections with respect to FIG. 2.

Depending on the embodiment variant, the user (the insured person) is requested, before or after refueling the motor vehicle 1, by the control application 22 via the display 24 to connect the data carrier 11 to the reading device 23 in step S1, that is to say to introduce the data carrier 11 into the reading device 23 (in a contact based fashion) or to present it in the interface region of the reading device 23 (in a contactless fashion). The control application 22 continues with the execution of step S2 only if the data carrier 11 is connected to the data input terminal 2 via the reading device 23.

In step S2, the control application 22 reads, by means of the reading device 23, the vehicle identifier stored on the data carrier 11, and said reading device 23 stores said identifier. In step S2 the control application 22 additionally reads and stores a service provider identifier which is stored on the data carrier 11 and which determines the insurance company.

In step S3, the control application 22 checks, by means of the reading device 23, whether a distance traveled data item of the motor vehicle 1 is stored on the data carrier 11. If a distance traveled data item is stored on the data carrier 11, the latter is read by the control application 22 in step S4 and buffered in step S8. Otherwise, the control application 22 continues in step S5.

In step S5, the control application 22 checks whether a distance traveled data item of the motor vehicle 1 has been received from the transmitting device 14 by the receiving device 25 on the basis of periodic transmission by the transmitting device 14 or whether a distance traveled data item is received from the transmitting device 14 on request by the receiving device 25. If a distance traveled data item has been received from the transmitting device 14 by the receiving device 25, said distance traveled data item is received by the control application 22 in step S6 and buffered in step S8. Otherwise, the control application 22 continues in step 7.

In step S7, the control application 22 requests the insured person, via the display 24, to read off the current distance traveled from the display 15 of the motor vehicle 1 and to input it by means of the operator control elements 21. In step S8, the distance traveled data item which is input is buffered by the control application 22.

In step S9, the control application 22 generates a transaction record which comprises a uniquely defined terminal identifier of the data input terminal 2, the vehicle identifier which is buffered in step S2, the distance traveled data item which is buffered in step S8, as well as the quantity data item, received from the fuel pump 3, for the fuel which is input into the motor vehicle 1, and possibly a time/date data item and a price data item.

In step S10, the control application 22 transmits the transaction record to the control center 5 which is determined by the service provider identifier stored in step S2. As is schematically illustrated in FIG. 1, depending on the embodiment variant said transaction record can also be transmitted to the billing point 6 which passes on the transaction record to the insurer's control center 5.

The transaction record is received in the control center 5 by the data recording module 51 and stored assigned to the respective vehicle identifier of the motor vehicle 1 in the data base 53. In addition, a time/date stamp is stored assigned to the transaction record. In order to recognize incorrectly specified distances traveled, the control center 5 carries out corresponding plausibility checks.

Details will not be given here on the sequences relating to confirmation and troubleshooting for the communication between data input terminal 2 and insurer, data input terminal 2 and control center 5 as well as data input terminal 2 and transmitting device 14.

On the basis of the transaction records which have been received in the billing period for the motor vehicle 1, the premium calculating module 52 calculates periodically, for example every month, every two months or every three months or annually, a new insurance premium which is dependent on the mileage which is determined. For this purpose, the premium calculating module 52 calculates the total distance traveled by the respective motor vehicle 1 in the billing period. If the data items in the received transaction records do not cover the entire time period of the billing period, the total distance traveled is calculated on the basis of adding the recorded distance traveled data items for the billing period. The insurance premium for the billing premium is obtained as a function of the total distance traveled by the motor vehicle 1 in the billing period, for example on the basis of a stored premium table.

In one variant, the premium calculating module 52 also takes into account, in addition to the total distance traveled, the geographic positions which are traveled through in the billing period and which are determined by the premium-calculating module 52 on the basis of the recorded terminal identifier. For this purpose, the data base 53 comprises, for example, a terminal table in which the terminal identifiers are respectively assigned to geographic positions and/or regions. Depending on the geographic region and traffic region which has been frequented by the motor vehicle 1, the premium calculating module 52 determines a different insurance premium for the billing period, for example on the basis of a corresponding premium table.

Finally, in a further variant the premium calculating module 52 additionally also takes into account the quantity of fuel consumed in the billing period, said quantity being determined by the premium calculating module 52 on the basis of the received transaction records. Depending on the ratio of the determined consumed quantity of fuel to the total distance traveled, the premium calculating module 52 determines a different insurance premium for the billing period, for example on the basis of a corresponding premium table.

The billing module 53 bills the insured person with the calculated motor vehicle insurance premium and preferably the costs for the total determined fuel quantity which has been input into the motor vehicle in the billing period. As an incentive to transmit the distance traveled data item, the price for the fuel quantity is calculated at a reduced price.

1-14. (canceled)

15: A computer based system for recording mileage of a motor vehicle to determine a motor vehicle insurance premium, comprising:
a computer based control center;
a portable data carrier with a vehicle identifier stored therein for a motor vehicle; and
a data input terminal which is connected to a fuel pump and is configured to read the vehicle identifier from the data carrier when the data carrier is connected to the data input terminal, to receive a distance traveled data item from the motor vehicle and to transmit a transaction record to the control center via a telecommunications network, the transaction record comprising the vehicle identifier and the distance traveled data item,
the control center being configured to store a plurality of transaction records assigned to the motor vehicle, in each case with a time data item, to determine, as a function of stored distance traveled data items, a total distance traveled by the motor vehicle in a defined calculation period, and to determine the motor vehicle insurance premium for the calculation period as a function of the total distance traveled.

16: The system of claim 15, wherein the system further comprises a writing device which is connected to an odometer of the motor vehicle, the writing device is configured to store a distance traveled, measured by the odometer, in the data carrier when the data carrier is connected to the writing device, and the data input terminal is further configured to read the distance traveled from the data carrier when the data carrier is connected to the data input terminal.

17: The system of claim 15, wherein the system further comprises a transmitting device which is connected to an odometer of the motor vehicle, the transmitting device being configured to emit a distance traveled measured by the odometer, and the data input terminal is further configured to receive the distance traveled from the transmitting device when the data carrier is connected to the data input terminal.

18: The system of claim 15, wherein the transaction record comprises a terminal identifier, and the control center is configured to determine, on the basis of the terminal identifier, a geographic position which is traveled through by the motor vehicle in the calculation period, and to determine the motor vehicle insurance premium as a function of geographic positions traveled through.

19: The system of claim 15, wherein the data input terminal is further configured to receive a quantity data item from the fuel pump, which quantity identifier indicates how much fuel has been input into the motor vehicle by the fuel pump, the data input terminal is configured to insert the quantity data item for the fuel into the transaction record, and the control center is configured to determine, as a function of stored quantity data items of the fuel, a total fuel quantity which is input into the motor vehicle in the calculation period and to determine the motor vehicle insurance premium as a function of the total fuel quantity.

20: The system of claim 15, wherein the data carrier comprises a stored service provider identifier, and the data input terminal is configured to read the service provider identifier from the data carrier and to transmit the transaction record to the control center which is determined by the service provider identifier.

21: The system of claim 15, wherein the data carrier is embodied as a chip card with a contactless and/or contact based interface, the vehicle identifier is assigned to an insured person, and the control center is configured to calculate the motor vehicle insurance premium for the insured person for the calculation period and to calculate costs for a total fuel quantity input into the motor vehicle in the calculation period, the total fuel quantity being determined from quantity data items of the fuel which is inserted into the transaction record by the data input terminal.

22: A computer implemented method for recording mileage of a motor vehicle to determine a motor vehicle insurance premium, comprising:
connecting a portable data carrier to a data input terminal which is connected to a fuel pump;
reading a vehicle identifier stored on the data carrier for a motor vehicle by the data input terminal;
receiving a distance traveled data item for the motor vehicle in the data input terminal;
transmitting a transaction record to a computer based control center via a telecommunications network, the transaction record comprising the vehicle identifier and the distance traveled data item;
storing a plurality of transaction records assigned to the motor vehicle, in each case with a time data item, by the control center;
determining a total distance traveled by the motor vehicle in a defined calculation period, as a function of stored distance traveled data items, by the control center; and
determining the motor vehicle insurance premium for the calculation period as a function of the total distance traveled by the control center.

23: The method of claim 22, further comprising connecting the data carrier to a writing device which is connected to an odometer of the motor vehicle, storing a distance traveled, measured by the odometer, in the data carrier by the writing device, connecting of the data carrier to the data input terminal, and reading the distance traveled from the data carrier by the data input terminal.

24: The method of claim 22, further comprising emitting a distance traveled, measured by an odometer of the motor vehicle, by a transmitting device which is connected to the odometer, connecting the data carrier to the data input terminal, and receiving the distance traveled from the transmitting device by the data input terminal when the data carrier is connected to the data input terminal.

25: The method of claim 22, further comprising determining a geographic position, traveled through by the motor vehicle for the calculation period, by the control center on the basis of a terminal identifier which is contained in the transaction record, and determining the motor vehicle insurance premium as a function of geographic positions traveled through by the control center.

26: The method of claim 22, further comprising transmitting a quantity data item for fuel which has been input into the motor vehicle from the fuel pump to the data input terminal which is connected to the fuel pump, inserting the quantity data item for fuel into the transaction record, determining a total fuel quantity, input into the motor vehicle for the calculation period, by the control center as a function of stored quantity data items for the fuel, and determining the motor vehicle insurance premium by the control center as a function of the total fuel quantity.

27: The method of claim 22, further comprising reading a service provider identifier from the data carrier by the data input terminal, and transmitting the transaction record to the control center which is determined by the service provider identifier.

28: The method of claim 22, further comprising assigning the vehicle identifier in the control center to an insured person, calculating the motor vehicle insurance premium for the insured person for the calculation period by the control center, and calculating the costs for the insured person for a total fuel quantity, input into the motor vehicle in the calculation period, by the control center, the total fuel quantity being determined from quantity data items for the fuel which are inserted into the transaction record by the data input terminal.
